(19) United States
(12) Patent Application Publication
(10) Pub. No.: US 2026/0249111 A1
(43) Pub. Date: Aug. 27, 2026

(54) SYSTEMS AND METHODS FOR CHECKING PERSONAL PROTECTION DEVICE FUNCTIONALITY

(71) Applicant: 3M INNOVATIVE PROPERTIES COMPANY, St. Paul, MN (US)

(72) Inventors: Caroline M. Ylitalo, Stillwater, MN (US); Marie D. Manner, St. Paul, MN (US); Nicole V. McCullough, St. Paul, MN (US)

(21) Appl. No.: 18/877,229

(22) PCT Filed: Jun. 29, 2023
(86) PCT No.: PCT/IB2023/056794

§ 371 Date: Dec. 19, 2024

Related U.S. Application Data
(60) Provisional application No. 63/367,522, filed on Jul. 1, 2022.

(51) Int. Cl. A62B 27/00; A41D 13/11; G01J 5/00; G01J 5/08; G01M 3/04

(52) U.S. Cl. CPC A62B 27/00; G01J 5/0859; G01M 3/04; A41D 13/1161; G01J 2005/0077

(57) ABSTRACT

A system for a PPE device is presented that includes an infrared camera that captures an image sequence of a user wearing the PPE device. The system also includes a gas profile generator that analyzes the image sequence and generates a gas profile of the PPE device. The system also includes a PPE identifier that identifies a component of the PPE device. The system also includes an analyzer that based on the generated gas profile, generates a function status of the component of the PPE device. The system also includes a communication component that communicates the status.

### BACKGROUND

Many PPE devices include seals that maintain a barrier between the wearer and the external environment, such as dust, mist, bacteria, etc., and are widely used in specific working environments and daily life. Respiratory protection devices and other face coverings are designed to provide a barrier to particulates and airborne or droplet-borne diseases, both by keeping exhalations from an infected individual contained and by providing a barrier from the coughs or exhalations of others. PPE have been required for healthcare and many industrial environments for years, and have seen increasing use as COVID-19 has required their usage in public places globally.

### SUMMARY

An objective of the present invention is to provide systems and methods for checking the functionality and fitness of PPE worn by an individual in an environment. In-situ seal checks, without significant disruption to the individual, can more accurately detect issues and provide feedback to the individual, which can better protect them from particulates, harmful organic vapors and gas, airborne pathogens or other risks. Using infrared imaging to detect CO₂ flow patterns provides a contact free, quick way to evaluate PPE valve functionality, seals, locations of potential cracks or leaks, and provide feedback without significant disruption to the wearer of the PPE. Monitoring PPE functionality may increase worker safety. However, while infrared imaging is described herein as one example of technology that can be used to image CO₂, it is expressly contemplated that other suitable technology may be used in other embodiments.

A system for a PPE device is presented that includes a camera camera that captures an image sequence of a user wearing the PPE device. The image sequences are captured using a filter or other technology that allows for CO₂ flows to be detected. The system also includes a gas profile generator that analyzes the image sequence and generates a gas profile of the PPE device. The system also includes a PPE identifier that identifies a component of the PPE device. The system also includes an analyzer that based on the generated gas profile, generates a function status of the component of the PPE device. The system also includes a communication component that communicates the status.

### BRIEF DESCRIPTION OF THE DRAWINGS

The embodiments of the present invention are described below merely as examples with reference to the accompanying drawings. In the accompanying drawings, the same features or components are represented by the same reference numerals, and the accompanying drawings are not necessarily drawn to scale. Further, in the accompanying drawings:

FIG. 1 is a view of a respirator.

FIGS. 2A and 2B illustrate respiratory protection devices (RPDs) worn by users in which embodiments of the present invention may be useful.

FIG. 3 illustrates a schematic of a system for checking functionality of an RPD worn by an individual in an environment in accordance with embodiments herein.

FIGS. 4A-4C illustrate how systems and methods herein may be used to improve the fit of an RPD for a user.

FIGS. 5A-5F illustrate performance of different cloth face coverings using systems and methods described herein.

FIGS. 6A-6C illustrate valve functionality monitoring in accordance with embodiments herein.

FIGS. 7A-7B illustrate the effect of foam material on exhalation patterns.

FIGS. 8A and 8B illustrate the effects of multiple PPE on exhalation flowpaths.

FIG. 9 illustrates a method of evaluating PPE by monitoring CO₂ flows in accordance with embodiments herein.

FIG. 10 illustrates a schematic of a PPE evaluation system in accordance with embodiments herein.

FIG. 11 illustrate an environment in which embodiments herein may be useful.

FIG. 12 illustrates an example mobile application for evaluating a respiratory protection device on a wearer in accordance with embodiments herein.

FIG. 13 illustrates a PPE evaluation system architecture.

FIGS. 14-16 illustrate example devices that can be used in embodiments herein.

### DETAILED DESCRIPTION

The following descriptions are substantially merely exemplary, and are not intended to limit the present invention, the application, and the use. It should be understood that in all of the accompanying drawings, similar reference numerals represent the same or similar parts and features. The accompanying drawings illustratively show the idea and principles of the embodiments of the present invention, but do not necessarily show specific size of each embodiment of the present invention and the scale thereof. In some parts of specific accompanying drawings, related details or structures of the embodiments of the present invention may be illustrated in an exaggerated manner.

The use of personal protective equipment (PPE) has become an important part of the strategy to limit the spread of respiratory infections. Respiratory protection devices (RPDs), in particular, have become increasingly important globally as COVID-19 has spread. Two types of respiratory protection devices are in increasingly common use: filtering facepiece respirators (FFRs, referred to as “respirators” herein) and face masks (commonly called masks, often made of cloth). As used herein the term “respiratory protection devices” may refer to respirators, face masks, or other facial coverings.

The term “face mask” generally refers to a face covering that inhibits droplets from the wearer from spreading, e.g. from a cough or a sneeze. However, face masks often provide little or no protection against droplets from another individual. FFRs, in contrast, are designed to seal to a user's face, such that inhaled air is forced through one or more filter layers, such that most droplets, bioaerosols, and particulates are removed from inhaled air before it reaches a wearer. Additionally, some FFRs include charged fibers that attract aerosols or particulates, providing increased protection.

Filtering facepiece respirators (FFRs) are sometimes referred to as disposable respirators (DRs). When worn properly, FFRs are designed to protect the wearer by removing harmful particles from inhaled air. FFRs are regulated by the National Institute for Occupational Safety and Health (NIOSH). To provide the required level of protection, an FFR must seal to the wearer's face, preventing gaps between the respirator and the wearer's skin since such gaps can allow contaminated air to leak into the breathing zone of the wearer. Therefore, tight fit of the FFR to the face of the wearer is essential.

Respiratory protection devices are mass produced with the goal of fitting many different facial structures, including male and female, high or low cheekbones, prominent jaws, etc. Additionally, respiratory protection devices are often worn during activity, such that the wearer may have different facial expressions during use, may walk or run, may sweat or laugh. Additionally, different types and different models of respiratory protection devices may be worn at different facial positions for the same user, depending on usage or activity.

Ideally, when worn, a respiratory protection device should fit the contour of the face of a wearer to form good sealing between the respirator and the face of the wearer. However, the contour of the face of the wearer is not the same between individuals, and there can be large differences from individual to individual. The contour of the nose is complex and fluctuates; it is often difficult to form a good seal, and a gap is often present between the respiratory protection device and the nose area of the wearer, resulting in a poor sealing effect. As a result, dust, mist or bacteria, virus, fungi in an environment where the wearer is located will be in contact with the wearer through the gap and is inhaled by the wearer, thus affecting the protective effect of the respirator. Additionally, the exhaled breath of the wearer will also be discharged upwards through this gap. For the case where the wearer wears glasses, if the temperature in the respirator is higher than the ambient temperature, the exhaled breath will cause fogging and affect the wearing experience of the wearer.

Therefore, in order to improve the protective effect of a respiratory protection device and improve the wearing experience, it is expected that the respiratory protection device can fit the contour of the face of the wearer and achieve good sealing between the respiratory protection device and the face of the wearer. In some RPDs, a metal or plastic nose strip with a memory effect is used to hold the RPD against a face of an individual. However, other sealing or seal-improving options may be used, including a shaped nose foam as described in U.S. Provisional Patent Application with Ser. No. 63/201,604, filed on May 6, 2021.

The RPD should stay in place on an individual's face during any time the user is exposed to potentially harmful particulates or aerosols. Many users of RPDs do not remain stationary during a workday, but move around, speak, walk, bend, run, etc. For example, in an industrial setting a user may wear a respiratory protection device for one, two, four or even 8 hours while a clinician in a hospital may wear a respiratory protection device for an entire shift (8 hrs) or perhaps even a double shift (16 hrs). It is conceivable, potentially even likely, that an RPD may move during this time, potentially breaking the seal to the wearer's face. Detecting when an individual's RPD no longer adequately seals to their face, and is no longer providing sufficient protection, increases safety in a workplace. It is important that systems and methods for checking a system be simple to use or interact with, provide quick feedback, and be touch-free, so that an individual does not lose significant amounts of time during a shift. Additionally, it is desired that systems and methods not rely on a component built into the RPD, as it is desired to keep costs of individual RPDs low.

Ideally, every time a user puts a mask on, they should do a fit check. In a hospital setting, this may require a doctor to do up to fifty times in a day, every time they enter a new patient room or come back from a break, etc. For users new to fit checks, it may also be difficult to validate that each fit check is done correctly.

Additionally, many respirators have exhalation valves positioned within the filter portion of a respirator. A valve, if functioning properly, opens only when a user exhales, directing hot air out of the dead space between the user's face and the respirator, helping the user to feel cooler.

Even if a fit check is done properly, it does not assure that a valve is functioning properly. A system that allows for visualizing exhalations of a wearer of a respirator allows for a user to get an understanding of whether or not the respirator fits and whether or not the respirator functions correctly, including the valve.

Exhaled air is often warmer, and has more moisture, than ambient air. If not directed away from the mask properly, this can result in fogging of other PPE—such as safety glasses, face shields, etc. It is, therefore, important for manufacturers of PPE, particularly respirators, to understand how exhaled breath will flow through filter media.

A system is desired that takes the uncertainty out of whether or not a user is correctly wearing their mask, and whether the mask fits correctly and is functioning properly. It is desired that a system provide a non invasive, easy and intuitive way to visualize exhaled air flow as means to assess the fit of a respirator worn by a person.

Carbon dioxide is the by-product of human body metabolism typically exchanged from the blood in the lungs and expelled into the atmosphere in exhaled breath. The typical carbon dioxide content in exhaled breath of a healthy human is between 4-6% by volume depending on the metabolic rate of said human. In the atmosphere, carbon dioxide concentration is 400-500 ppm (parts per million), which corresponds to 0.04-0.05% by volume. The carbon dioxide content of the exhaled breath is therefore about two orders of magnitude greater than the surrounding atmosphere. This large contrast in carbon dioxide concentration can be utilized for exhaled breath visualization.

Carbon dioxide (similar to most molecular gases) has individual absorption bands in the infrared spectral range. This unique absorption band results from the rotational-vibrational transitions of the molecule giving “fingerprint” signature for carbon dioxide. Specific signature of carbon dioxide gas in the mid-wave infrared range (from 3-5 micrometers) arises from the asymmetric stretching mode of the carbon-oxygen double bond (absorbing around 4.3 micrometers) and it lies isolated from absorptions of other gasses in the atmosphere. Therefore, one can use mid wave infrared thermal camera designed for detection of carbon dioxide to generate optical gas imaging, delivering real-time qualitative visualization of exhaled breath air currents. However, other imaging techniques may also be suitable.

Described herein are systems and methods that may be useful for environments in which users wear respiratory protection devices generally, and particularly useful for individuals wearing respirators with exhalation valves. Systems and methods herein may be useful for in-situ seal checks for individuals wearing RPDs.

Described herein are systems and methods that allow for comparing build-up of exhaled breath around the face in valved versus non-valved filtering facepiece respirators and the effectiveness of the same valve, on different respirators. The valves may function differently due to respirator geometry and/or facial geometry. The effectiveness of respirator material and valve material may also be evaluated. Ideally, a respirator causes exhaled breath to exit away from the wearer so that stale air is not re-inhaled. Systems and methods herein may evaluate whether or not the exhaled breath is successfully exiting through the exhalation valve. If no visible breath is seen, or if the breath is not being directed out of the valve, then there may be a leak. In some embodiments, based on the profile of carbon dioxide leaving the mask, a leak may be detected.

Described herein are systems and methods that allow for better understanding of material functionality, for example the permeability of a foam or the function of a valve.

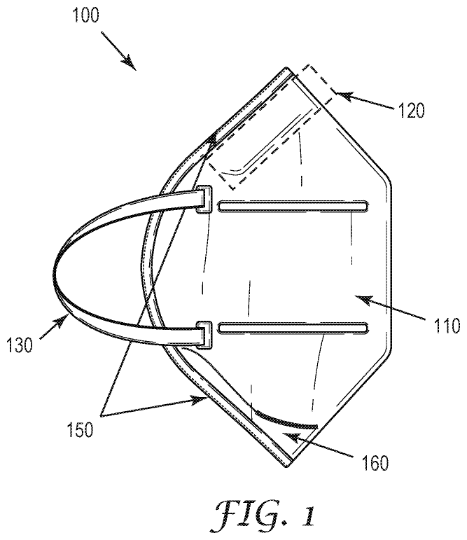

FIG. 1 is a view of a respirator. Respirator 100 is an earloop respirator. In the example shown in the drawing, respirator 100 is a foldable earloop respirator. However, the present invention is not limited thereto, and may also be applied to non-foldable or non-earloop respirators as well as to other RPDs more broadly. In the manufacturing process of the first respirator 100, a formable nose piece (often metal, however other suitable materials are envisioned) is attached to an inner or outer side of a respirator main body 110, within area 120. When the first respirator 100 is worn, a lanyard 130 is hung on the left and right ears of the wearer, respectively.

It is intended that a user adjust respirator 100 so that the nose of the wearer is accommodated by adjusting the formable nose piece such that area 120, and the exterior edge 150 conform to the contour of the face of the wearer to closely fit the periphery of the nose of the wearer, thus reducing or even eliminating the gap between the respirator and the nose of the wearer. A good seal between respirator 100 and the face of the wearer is important for safety concerns.

Earloops 130, or another tension device such as a headband, pull RPD 100 toward the face of a user, causing a seal to form on a face contacting portion of the RPD. A seal may not necessarily form along edges 150. For example, a seal may form along line 160, where a user's chin contacts the RPD along a jawline.

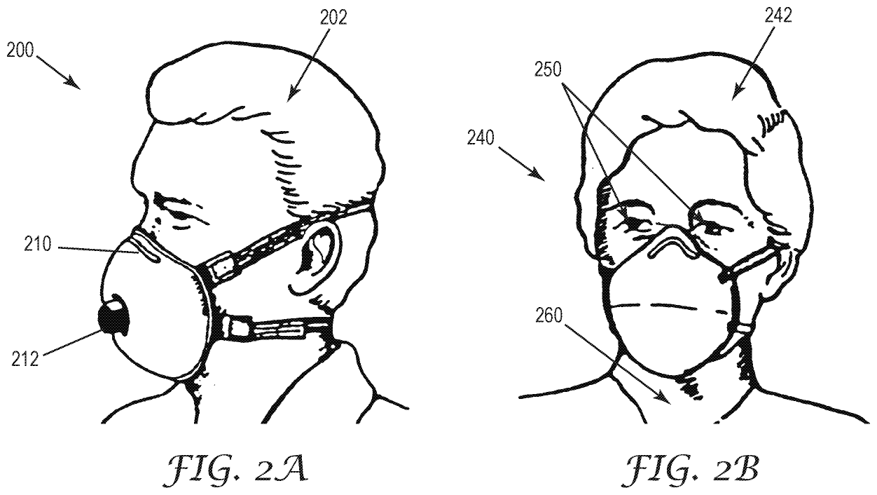

FIGS. 2A and 2B illustrate a respiratory protection device worn by a user in which embodiments of the present invention may be useful. As illustrated in FIGS. 2A and 2B, respiratory protection devices 200 and 240 can be secured over a user's face using a variety of methods other than the lanyard illustrated in FIG. 1.

Respiratory protection devices 200 and 240 are intended to form a seal along the edges of the RPD, where the face-contacting side contacts the face. If an imperfect seal is present, then exhaled air may be forced upward, out of the nose portion as indicated by arrows 250, and/or downward, out through the chin portion, as indicated by arrow 260, causing discomfort for some users, and may also cause respiratory protection devices 200, 240 to move up or down along a nose of user 202 and 242. A user can adjust a nose clip 210 to improve the fit of respiratory protection devices 200, 240. It may also be necessary, if a particular RPD 200, 240 does not fit well, to move up or down in size, or to switch to a different model of RPD.

RPD 200 has a valve 212 that allows exhaled air to flow from user 202 out of the filter portion of RPD 200. While an exhale of user 242 may diffuse more evenly through RPD 240, it should flow mainly through valve 212, which directs it away from the user 202. Valve 212 should operate solely as a one-way valve, opening only during an exhale, and not an inhale.

All objects emit infrared radiation as a function of temperature. The emitted thermal energy can be seen using imaging technology that can detect or visualize the infrared radiation. An infrared camera, for example, may be used. IR waves may be captured in any of four bands—near-IR around 0.75 μm, middle IR around 3-6 μm, far IR around 6-15 μm, or extreme IR around 15-100 μm.

Additionally, using an IR camera with a CO₂ filter, allows for the visualization of the exhaled breath flow patterns Carbon dioxide has distinct absorption bands at around 15 and 4.3 micrometers. While simply using infrared to detect the heat of a disposable respirator wearer is possible, the heat escaping through the filter media, and the amount of heat retained in the filter media may significantly vary from wearer to wearer, may vary when a user is breathing heavily versus normally, and may vary by filter media.

Using an IR camera with a CO₂ filter (such as Flir GF343, FLIR Systems Inc)., it is possible to capture the path of escape of the wearer's exhaled breath, which contains higher levels of—carbon dioxide than the surrounding atmosphere, and which, under good seal conditions, must flow through the filter media and not escape through seals along the wearer's face. In contrast, a seal with leaks should allow more CO₂-rich exhaled breath to escape through a leak, compared to an over-all exit from the filter media. However, while the Flir GF343 is described herein, it is expressly contemplated that other technology, now existing or future developed, may be suitable.

As described herein, in some embodiments a computer vision system captures video imagery from an appropriate infrared camera configured with a CO₂ filter. Based on the captured images, a trained model can analyze the CO₂-rich exhaled breath flow patterns and provide an indication of whether or not an RPD, or other PPE device is functioning properly. For example, whether a seal is sufficient to a user's face, whether a user is wearing face straps in a position to encourage an adequate seal, whether and how a valve is functioning, and generally how the air in an exhale flows.

As described herein, PPE evaluation systems can be trained on different classes of PPE, for example well-fitting valved respirators, ill-fitting valved respirators, well-fitting non-valved respirators, ill-fitting non-valved respirators, etc. A set of seed data may be used to train a machine learning system to recognize gas flow patterns and determine whether a user is wearing a respiratory protection device correctly, whether the respirator fit can be improved, whether a valve is functioning properly, and even determine if a different RPD model would provide a better fit.

As described herein, a PPE evaluation system can generate a functionality metric for an RPD. The functionality metric may be, for example, a seal quality indication, a valve quality indication, a leak location, a strap placement indication, or another indication. Additionally, it may be possible, using systems herein, to determine a temperature of the breath inside the respirator, by detecting a temperature of the air exhaling the valve. This may indicate whether or not a worker is overheating or experiencing heat stress. Similarly, using systems and methods herein, it may be possible to analyze a breath rate of the wearer and detect whether a worker is exhaling faster than expected, which may indicate exhaustion. Such indications may be classified as comfort level indications and/or a worker safety notification. The functionality metric may also indicate which component, if any, is causing a leak.

The functionality metric can be generated by imaging CO₂-rich air flows around the respirator. CO₂-rich exhaled air flows should be concentrated and directed away from the valve during an exhale. Flows should not persist or ‘fog’ around the user's face, or drift upward to an eye protection PPE, such as a face shield, safety glasses or goggles, etc.

A fit indication may also be generated. For example, higher concentrations in only some locations mean a poor fit, such as concentrations visible near nose-clip means a poor fit around the nose. In another example, when using a poor-fitting respirator, the CO₂-rich exhaled air flows first and fastest through big leaks in the respirator seal since pressurized exhaled air will follow the path of least resistance. A properly fitted respirator will show no faster CO₂ movement and no CO₂ visible around the respirator seal; instead it will come through the filter media. When considering larger PPE devices, such as a full facepiece respirator, the CO₂-rich exhaled air should be visible near the exhalation valves at the beginning of an exhalation but should not be visible around the seal initially, only after the breath floats up and creates a cloud around the facepiece.

Currently, gas measurements can be taken by sensors positioned on the interior of the face mask, or by enclosing the wearer entirely in a hood or contraption to put particulate or gas in the area around the user to test the quality of fit. However, this requires sensors to be placed within a PPE and be functioning properly, or requires the user to stop a current activity to undergo fit testing. Instead, it is desired to have a system or method that can evaluate PPE functionality based on video imagery captured while a user is completing a current task. This can both give an accurate in-situ understanding of PPE functionality for the user during a given task, and also does not interrupt a user from completing said task.

Considering users 202, 242, it is possible to add seal check sensors to allow a user to obtain an instantaneous check of the functionality of RPDs 200, 240. However, this requires a user 202, 242 to have purchased an RPD with such a sensor, which will have an increased cost compared to an RPD without a sensor. Additionally, at least some sensors require the user to activate, or touch to initiate a seal check. This is not desirable as it requires a user to interrupt their activity and touch their mask (which may be particularly undesirable in a healthcare setting), which may also cause the mask position to change.

It is desired to be able to monitor a variety of RPDs. For some RPDs, a pressure drop sensor within a mask can indicate valve effectiveness by comparing inhalation and exhalation pressure. A well functioning valve should result in a 30-50% reduction in exhalation pressure compared to inhalation pressure for the same respirator worn by the same person.

In industries where tight-fitting facepieces, such as RPDs are required, fit testing is the responsibility of the employer, and may be done annually or more frequently. Fit testing is done to ensure that an individual has an RPD that provides a good seal with a tight-fitting mask. Because face structures can vary widely between individuals, fit testing should happen during the initial selection of an RPD, before it is worn in a hazardous environment. Even when done correctly, judging the quality of a fit does not necessarily result in a numeric value that clearly provides an indication that a fit is good or poor.

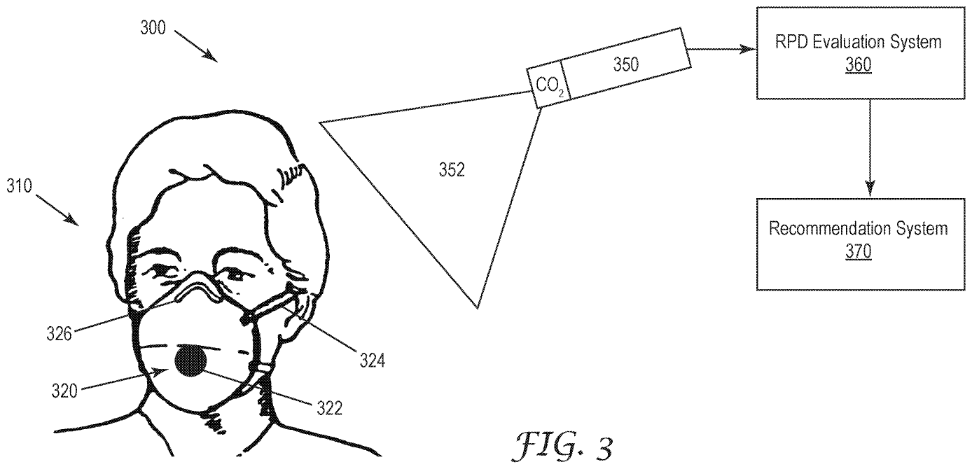

FIG. 3 illustrates a schematic of a system for checking functionality of an RPD on an individual in an environment in accordance with embodiments herein. RPD evaluation system 360 is located in an environment 300. A user 310 is in environment 300 and is wearing an RPD 320. Environment 300 may be a healthcare environment, an industrial environment, or any other environment where RPDs 320 are required PPE for individuals 310.

As discussed in greater detail herein, an environment 300 may include one or more IR imaging cameras with a CO₂ filter 350, each with a field of view 352. In some embodiments, camera 350 may be a mounted camera, for example a security camera mounted in a corner or on a wall. In some embodiments, camera 350 may be a semi-mobile camera, for example in a fixed position with a pan and tilt assembly. In some embodiments, camera 350 is a mobile camera, for example mounted on another user or mounted on a mobile robot capable of moving about environment 300. It is also expressly envisioned that environment 300 may have multiple cameras, each positioned with differing fields of view 352. However, for ease of understanding, only one camera 350 is illustrated in FIG. 3.

IR camera with a CO₂ filter 350 has a field of view 352 that captures an image, series of images, or video of user 310 when user 310 enters field of view 352. It is described herein that, in some embodiments, a video is captured and analyzed. However, it is expressly contemplated that the analysis may be done with images representing different times during a breathing sequence. For example, if an image processor or analyzer is located remotely from camera 350, it may be desired to send smaller image data files than a full video file, for increased speed of results.

After receiving collected image or video, RPD evaluation system 360 may conduct an analysis using a machine learning trained analyzer. The machine learning trained analyzer may compare the captured image data against a database and, based on the comparison, generate a function indication for the RPD 320. The function indication may indicate a detected leak or other functional problem. Recommendation system 370 may then, based on the function indication, provide a recommendation for user 310. The recommendation may be, for example, to change a position of strap 324. Placement of strap 324 may change how tension is applied to the face covering portion of RPD 320. The recommendation may also be to reform a nose portion 326 of RPD 320. The recommendation may also be that a different model or type of RPD may provide a better fit or better protection. Recommendation system 370 may utilize a second trained machine learning algorithm or may benefit from the same trained machine learning algorithm of RPD evaluation system 360.

RPD evaluation system 360 may also apply the trained machine learning algorithm to determine functionality of valve 322. Valve 322 is functioning correctly if it is operating as a one-way valve and only letting exhaled air out of RPD 320. Valve 322 is not functioning correctly if air is clouding in front of the face of user 310. Valve 322 is functioning correctly if exhaled air is directed away from user 310. Valve 322 should also direct airflow downward, so that it does not fog any protective eyewear of user 310.

RPD evaluation system 360 may actively monitor user 310 as they move through an environment. RPD evaluation system 360 may cause camera 350 to capture images periodically, or when a user 310 is detected, or based on recognition that a face of user 310 is within a field of view 352. RPD evaluation system 360 may also trigger image capture by camera 350 based on a motion sensor (not shown) or another indication that a user 310 is present.

Alternatively, RPD evaluation system 360 may operate by manual instruction. User 310 may actuate system 360, causing camera 350 to start taking images. System 360 may instruct the wearer to breathe in, for example, to clear the gasses around their face, and then, when prompted, exhale. The system may then take a few frames from that initial exhale. Based on the captured images, the analysis proceeds as discussed above.

The functional indication may be a numerical indication, e.g. valve 322 is allowing less than 30% of exhaled air to exit through the valve, while the remaining air is going through the filter media portion of RPD 320. Alternatively, the functional indication may be a quality indication—e.g. valve 322 is working or not working. The functional indication may also be an indication of whether the seal is adequate or not, an indication of whether (or where) a leak is detected, or may include instructions for improving a seal or improving functionality of a PPE, such as replacing a particulate filter that is experiencing high loading, resulting in high pressure drop across the filter.

Camera 350 may be any suitable IR camera that captures images in the IR portion of the light spectrum such as Flir GF343, FLIR Systems Inc. where the absorption band of CO₂ (at wavelength of 4.3 micrometers) can be detected. Camera 350 may capture a video stream, or images. Camera 350 may only capture images, or send captured images to PPE evaluation system 360, based on detection of individual 310 in field of view 352. Camera 350 may also, in some embodiments, capture a video stream but only send relevant images, or relevant image sequences, such as images during the beginning of an exhalation sequence.

In some examples, a machine learning algorithm may be used to train a computer vision system to detect the levels of CO₂ in the exhaled air which are noteworthy or relevant to a particular one of the applications described in this disclosure.

As an example, but not by limitation, the ML algorithm, for example a neural network, can be trained using two or more classes of image, to recognize or label conditions such as: class 01—CO₂ concentration is not elevated, class 02—CO₂ concentration is somewhat elevated, and class 03—CO2 concentration is elevated. Examples of the kind of neural network which can be trained to label images or otherwise distinguish between classes of image include the convolutional neural network (CNN). However, other suitable deep neural networks may also be used. Multilayer perceptrons (MLP) may also be used. Open-source libraries provide implementations of neural networks which may be trained in accordance with the content of this disclosure (e.g., Keras, TensorFlow). Neural networks which perform semantic segmentation annotation may also be used. Autoencoders, capsule autoencoders, and stacked capsule autoencoders are other examples of neural networks which may be used in whole or in part in the classification of images. Other applicable ML techniques for labelling images may involve the computation of texture features, such as SIFT, SURF, MSER, ORB, BRISK and other types of texture features known to one skilled in the art.

Training image data may be collected using a still-image camera or be derived from individual frames from a video camera (e.g., a high-frame rate video camera). One example of such a still-image camera is a FLIR A6751sc. In some examples, the camera may be built into a handheld mobile device or otherwise connected to a handheld mobile device (e.g., a cell phone). In some embodiments, a camera may be connected to a handheld mobile device via a cellular data connection, a WiFi™ connection or a Bluetooth™ connection. These examples specify C02 as the gas to be detected, but without loss of generality, other gases, smoke or particulates (such as air pollution) may also be subject to detection.

CO₂ imaging is a developing field. Currently, such technology is often used for imaging gas leaks in plants. More complicated methods of visualizing breath of a user of an RPD exist, such as Schlieren photography, which detects changes in the refractive index (flow density) induced by warm exhaled breath. However, Schlieren photography systems are difficult to set up, require expensive specialized optical elements, need a lot of space and are not portable. In contrast, systems herein utilize infrared-capturing cameras that are portable, and can be implemented as an IR filter over an existing camera system. Additionally, Schlieren images require subjects to stand facing parallel to a background mirror and will not provide any visibility when the person obstructs the view of the mirror.

With COVID-19 moving into the endemic stage, understanding whether individuals wearing masks are adequately protected is increasingly important. However, various infectious agents are known to be transmitted by aerosols produced during breathing, talking, coughing, sneezing, etc. Using a computer vision system to analyze images captured in the IR spectrum can allow for real-time characterization of exhaled airflow and evaluate the functionality of a particular RPD with and without an exhalation valve r other facial covering.

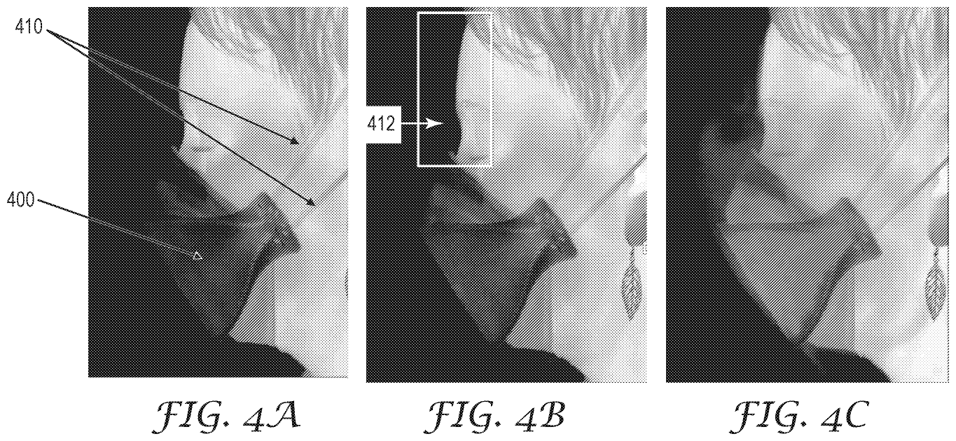

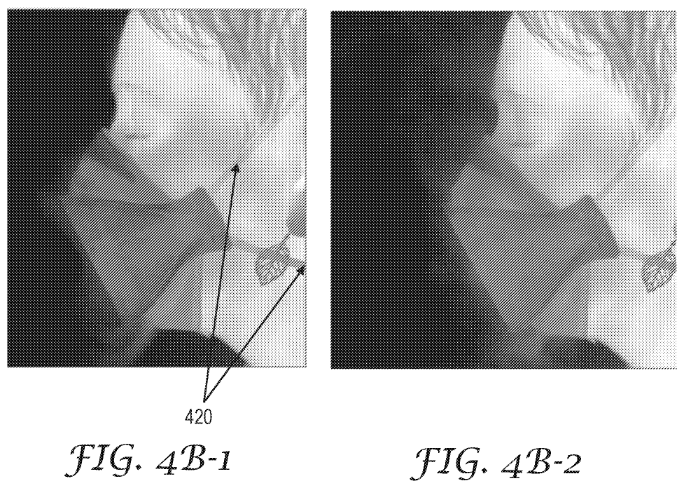

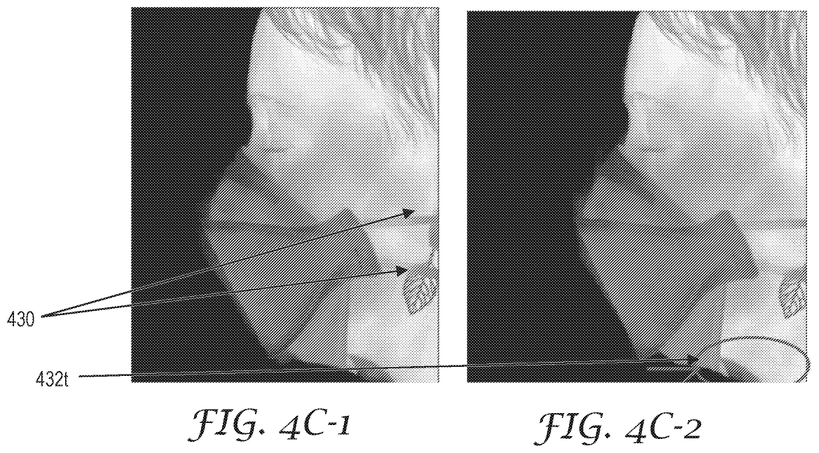

The CDC and NIOSH released a technical report in December 2020 called “Filtering Facepiece Respirators with an Exhalation Valve: Measurements of Filtration Efficiency to Evaluation Their Potential for Source Control” and said “Although the functioning of the exhalation valve was not evaluated in this study, NIOSH researchers inferred that the valves on some models may have remained mostly closed; this inference is based on low penetration findings such as measurements of <1% that would not be possible with an open exhalation valve (as demonstrated by model 65059520A in FIGS. 4A-4C). As an explanation, those FFRs whose valves did not open may have been designed to open at higher flowrates. The variability within each FFR model could also be explained by how the exhalation valve opens, with some models consistently opening to the same position and other models having variations with the valve even fluttering in the air currents.” This method can be used to clearly demonstrate to interested parties such as NIOSH and the CDC how valves work at different breathing rates (or different flowrates)

FIGS. 4A-4C illustrate how systems and methods herein may be used to improve the fit of an RPD for a user. Each of the images of FIGS. 4A-4C are images in sequence from a video, showing how the placement of RPD straps can affect the fit of an RPD to a wearer's face. In FIGS. 4A-1 to 4A-3, a user is wearing an RPD 400 with straps in a first position 410. First position 410 includes straps both positioned on the crown of a wearer's head contrary to user instructions requiring one strap to be positioned at the crown of the head and the second at the base of the neck. When both straps are too high, a leak 412 forms around the nose.

When a leak is detected by systems herein, a notification or alert may be generated and provided to the individual. The notification may be an indication of a detected leak, e.g. an indication of where leak 412 is detected. The notification may also provide a suggestion for how to correct the detected leak 412. While the example of leak detection is illustrated, it is also contemplated that other functionality may be monitored, such as valve operation.

FIGS. 4B-1 and 4B-2 illustrate the straps moved into a proper position 420, with no significant leakage illustrated. FIGS. 4C-1 and 4C-2 illustrates straps in a third position 430, positioned lower on the back of a user's head. This causes a leak 432 to form around the user's chin.

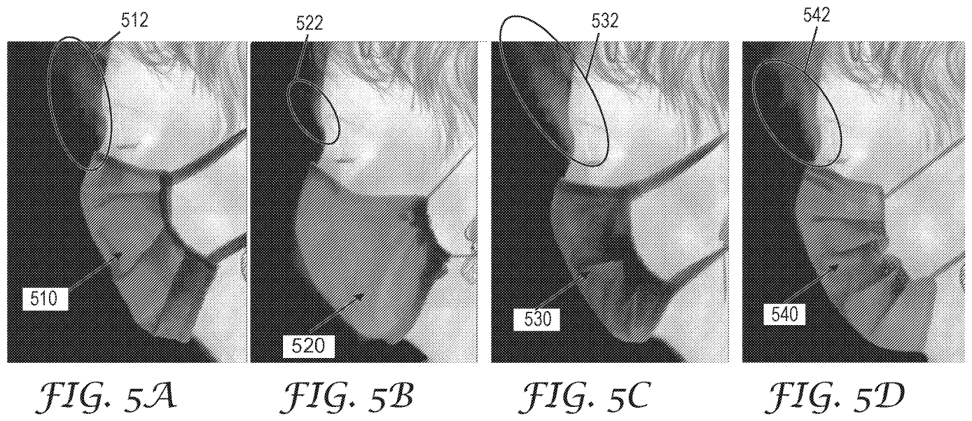

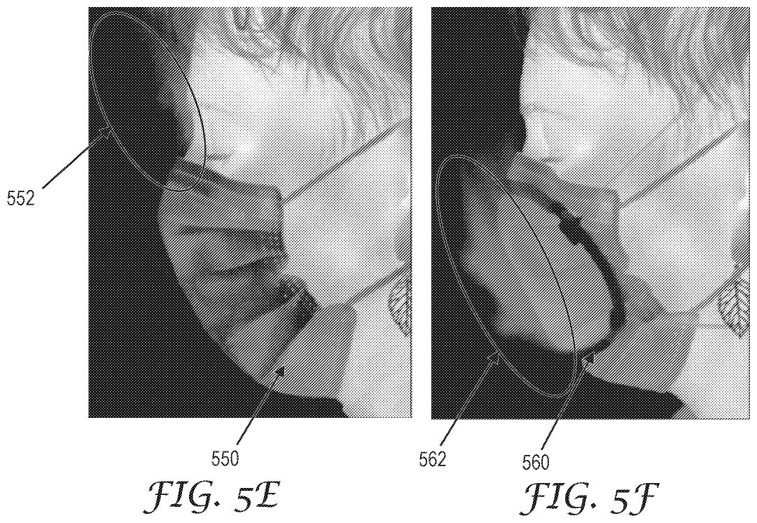

FIGS. 5A-5F illustrate performance of different cloth face coverings using systems and methods described herein. FIGS. 5A-5C illustrate three different cloth face coverings, 510, 520 and 530, respectively. As illustrated, face covering 510 shows exhaled air 512 escaping near the wearer nose. Face covering 520 has a leak allowing exhaled air 522 to escape and accumulate. Face covering 530 also allows exhaled air 532 to leak through the nose covering area. FIG. 5D illustrates a surgical style mask 540, and shows exhaled air 542 escaping from the nose section.

FIGS. 5E and 5F illustrate the benefits of using a mask fitter. Custom mask fitters may be made using 3D printing to better seal a cloth or surgical mask to a user's face, as illustrated in FIG. 5F. Systems and methods herein may be useful for evaluating modifications to an RPD. For example, PCT Application No. PCT/US2022/026641, filed on Apr. 28, 2022, discloses custom nose foams that may be generated based on a user's facial geometry.

As illustrated in FIG. 5E, a surgical mask 550 has poor seal around the nose causing leaked air 552 flowing from a nose area of the surgical mask. Once a fitting device 560 has been added, exhaled air 562 is forced to flow through the filter portion of the mask resulting in better protection to others.

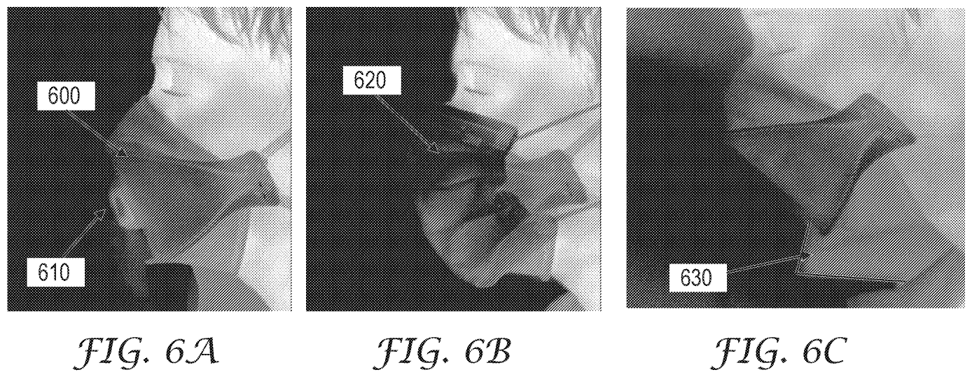

FIGS. 6A-6C illustrate valve functionality monitoring in accordance with embodiments herein. There is some concern by infectious decease experts that valved respirators do not adequately reduce the spread of airborne pathogens. For example, some airlines banned valved respirators during the height of the COVID-19 pandemic. FIG. 6A illustrates an RPD 600 with a valve 610. Valve 610 is working properly, directing exhaled air downward and away from the face of a user. FIG. 6B illustrates a valved respirator that has been covered with another mask, inhibiting the function of the valve. Exhaled air no longer flows easily away from, and down from, a user. In fact, FIG. 6B shows all exhalation that escapes from the valve is caught and distributed into the second layer of face covering. FIG. 6C illustrates a valved respirator where surgical tape has been used to cover the inside of the opening of the valve, to simulate a blocked or non-functioning valve. Exhaled air 630 is forced through other areas of the respirator, and almost no air escapes through the valve.

The CDC and NIOSH released a technical report in December 2020 called “Filtering Facepiece Respirators with an Exhalation Valve: Measurements of Filtration Efficiency to Evaluation Their Potential for Source Control” and said: “Some municipalities have banned the use of masks with exhalation valves [Department of Public Health Order of the Health Officer 2020], and airline industry leaders also prohibit their use [Alaska Airlines 2020; American Airlines 2020; Delta Airlines 2020; Southwest Airlines 2020].”

As illustrated herein, systems and methods can be used to verify function of a particular RPD model, size, etc. for safety. As illustrated herein, cloth face coverings direct air upward, potentially towards the person behind an airline passenger. Additionally, valved respirators with functioning valves may release exhaled air (up, down, or to the side). Systems and methods herein, therefore, could inform airlines and municipalities of appropriate countermeasures for using respirators with valves. It could also be used to demonstrate more practically the differences between respirator modifications that are NIOSH approved (e.g. covering the valve opening inside a FFR with 3M Multi Use Duct Tape) and those modifications which are not (covering the outside of a valved respirator with another covering, such as a cloth or surgical mask). FIG. 6C shows a valved Aura™ respirator (Model 9205+) with the valve covered (on the inside) with surgical tape. This model has no hard plastic to affix the tape to, so there may be some escape through the filter media under the edges of the tape.

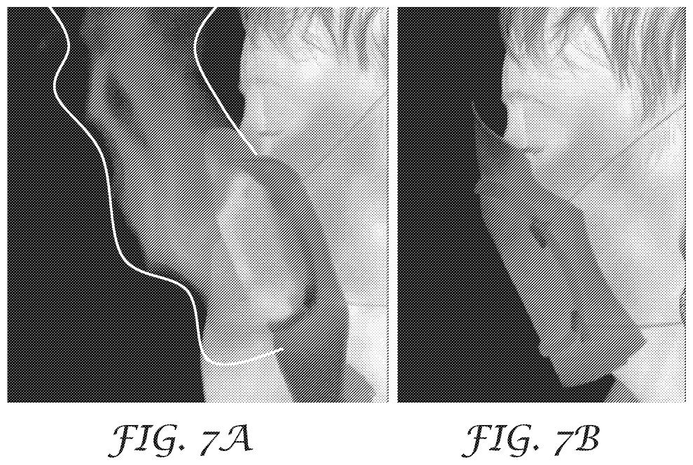

FIGS. 7A-7B illustrate the effect of foam material on exhalation patterns. FIGS. 7A and 7B are foams used in 3M AURA™ respirators. The foams were fixed to the wearer's face using a 3D printed mask fitter. FIG. 7A and FIG. 7B illustrate open cell and closed cell polyurethan foams, respectively. As illustrated, the foam of FIG. 7A allowed for breathability for a user, and assisted in directing exhalation away from the user's face. The foam of FIG. 7B has a film laminated on the surface to make it impermeable, which significantly inhibited breathing, which is why no significant exhalation is seen.

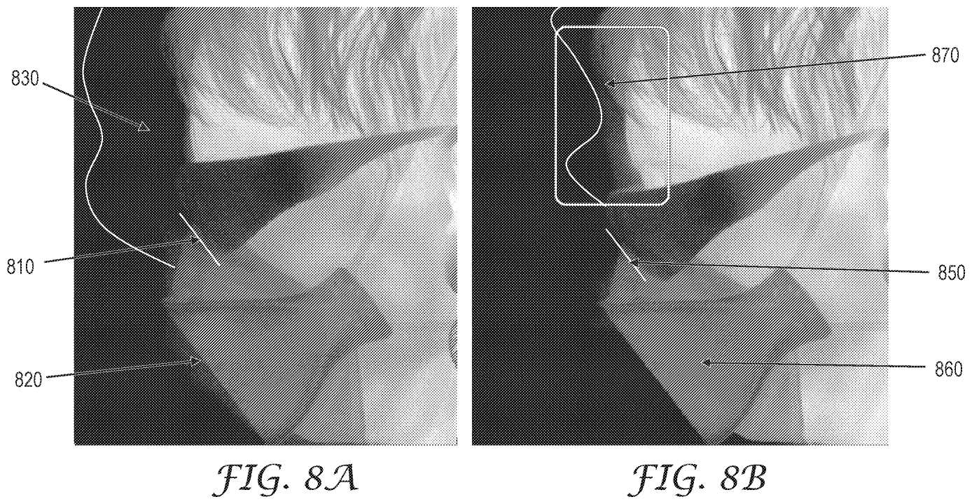

FIGS. 8A and 8B illustrate the effects of multiple PPE on exhalation flowpaths. FIG. 8A illustrates a user wearing safety glasses in a first position 810 relative to an RPD 820. Exhaled air has room to flow in front of, and around, safety glasses, as illustrated by exhalation cloud 830. In contrast, in a second position 850, glasses are further down a nose of a user, and exhaled air 870 has room to flow upward from RPD 860, between a user's face and safety glasses. This can cause eyewear fogging if the ambient temperature is lower than the exhaled breath temperature.

Systems and methods herein, upon visualizing a CO₂ flow pattern that could obstruct a user's vision by causing eyewear fogging, may provide a suggested change to the user. In the example illustrated in FIGS. 8A-8B, the suggestion may be to push safety glasses further up the bridge of the user's nose. Alternatively, it may be suggested that the user change size or model of safety glasses so that they naturally sit higher on the user's nose bridge. Alternatively, the system may suggest the user switch to a valved respirator where the exhaled air exits through the valve in a downward flow pattern away from the eyewear or safety glasses.

Systems and methods herein capture IR images with an IR camera and CO₂ filter, analyze the images against known CO₂ exhalation patterns associated with known RPD and other PPE, and determine functionality of PPE components. In some embodiments, background subtraction and image classification is done after image smoothing and aligning. Particle image velocimetry may also be used as an analysis tool. Deep learning algorithms, including neural nets, may also be used, in some embodiments.

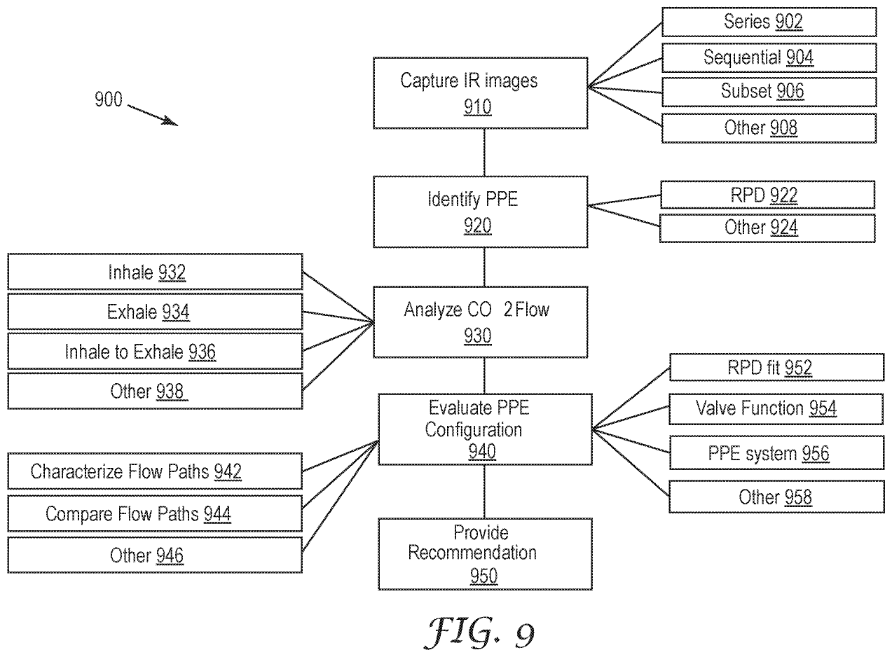

FIG. 9 illustrates a method of evaluating PPE in accordance with embodiments herein. Method 900 may be implemented in an environment where individuals require PPE protection. The environment may have one or more mounted, stationary, mobile or roving camera systems capable of taking IR photographs with a CO₂ filter. In some embodiments, the camera is worn by or built into equipment worn by another individual in the environment. Method 900 may proceed automatically, in some embodiments, when a person wearing PPE is detected within a field of view of a camera, which may be done using any known or future developed techniques. Detecting a person may involve detecting movement within a field of vision of a camera and identifying it as a human. Detecting a person may also include identifying the person, for example as a nurse vs a doctor, or as a particular individual, such as Nurse John Doe. In some embodiments, different PPE requirements may be necessary based on the identity of the identified person. For example, a nurse may require a respirator while a surgical mask may be sufficient for a doctor.

Systems and methods herein may be configured to compare retrieved images based on an identification of the individual or the PPE. For example, an RPD make and model may be identified and a machine learning system may conduct a comparison only against the same, or similar, make and model.

In block 910, images of an individual are captured using an IR camera with a CO₂ filter. Image capture may be triggered by a motion sensor detecting movement in a field of view of a camera, for example. Image capture may occur continuously, in some embodiments, and an individual may be detected in the captured images using an image analyzer. Other suitable detection mechanisms are possible.

A number of images may be captured, to ensure that sufficient data is available to analyze. In some embodiments, enough images need to be taken within a time limit to clearly see the movement of CO₂ in, around or through PPE of a user. The captured images may be a series of images captured by a camera, as indicated in block 902, or sequential frames of a video captured by a camera, as indicated in block 904. The camera may only pass on a subset of images captured, as indicated in block 906. For example, a video captured may have a high enough frame rate such that sequential frames are not needed to capture CO₂ flow patterns as a user inhales, exhales, or both. In embodiments where analysis is done remote from the camera, sending only a subset of frames may allow for faster data transmission and analysis. Other image selections, as indicated in block 908, are also expressly contemplated.

In block 920, a unit of PPE may be identified and isolated in the captured images. The PPE may be identified by referencing a PPE database for a manufacturer and model of PPE. Because CO₂ flow pattern is different between different PPE types, it may be important to identify not only a type of PPE (e.g. FFR), but a particular model number as well. The identified PPE may be an identified RPD 922 and/or other PPE 924. For example, CO₂-rich exhaled breath flows through an RPD 922 and may interact with other PPE 924 as well, such as protective eyewear, face shields, etc. It is important to ensure that the functionality of other PPE is not inhibited by a user's exhaled breath, if possible.

In block 930, CO₂ flow through the PPE is analyzed. The CO₂ flow pattern may be characterized based on captured images of a user during a period of inhale, as indicated in block 932. The CO₂ flow pattern may be characterized based on captured images of a user during a period of exhale, as indicated in block 934. The CO₂ flow pattern may be characterized based on a time period including both an inhale and an exhale, as indicated in block 936. Other time periods are also envisioned, as indicated in block 938. The CO₂ flow pattern may provide information about PPE functionality, including whether or not a good seal is achieved, whether or not the filter media of an RPD is defective or leaking, or whether a filter may have reached its end of service life due to particulate loading.

In block 940, the PPE configuration of a user is evaluated. The PPE configuration may include any PPE worn on a face of a user that may be affected by exhaled air flows. The evaluation may include characterizing flow paths 942 from and around PPE worn by a user, as indicated in block 944, and comparing those flow paths to a database of flowpaths, using a machine learning based algorithm, to determine whether all PPE is functioning properly. Other steps 946 may be taken as part of the evaluation.

Evaluation of a PPE configuration may include evaluating a fit of an RPD, as indicated in block 952, by determining whether a leak is present, whether straps are properly placed, etc. Evaluation of a PPE configuration may also evaluate a function of a valve 954, for example by determining whether exhaled air flows through the valve as expected. Evaluating the PPE configuration may also include evaluating how multiple PPE within the system interact together, as indicated in block 956. For example, as illustrated in FIGS. 8A-8B, placement of safety glasses affects functionality as it redirects flow of exhaled air, potentially causing fogging of the lenses.

Evaluating the PPE configuration may also include evaluating other functional aspects of PPE worn by an individual, as indicated in block 958. Evaluating the PPE device may include checking functionality of one or more components. Once a CO₂ flow profile is obtained, it may be compared against CO₂ profiles for similar PPE with known acceptable or known-unacceptable functionality. For example, the PPE device may have a filter and, based on the CO₂ flow pattern, out of the filter an amount of particulate loading may be estimated, such estimate can correlate with end of service life of said filter. It may also be possible to detect cracks or tears through which gas can escape. Additionally, it may be possible to detect improperly assembled PPE components. For example, a full SCBA respirator may experience leaks if one side is not clicked in correctly.

In block 950, a recommendation is provided regarding the PPE configuration. The recommendation may be output to a source, such as a display, a communications unit (such as a speaker), or a remote source. In some embodiments, the recommendation may also include a recommended adjustment, such as repositioning a nose clip or straps. The recommendation may also include other information, such as whether or not a valve is functioning correctly.

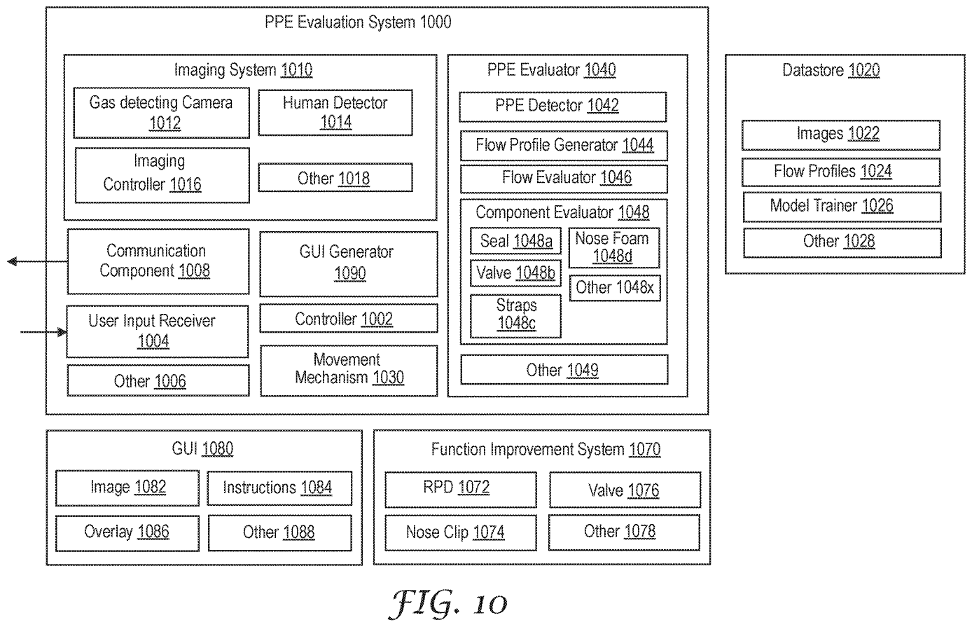

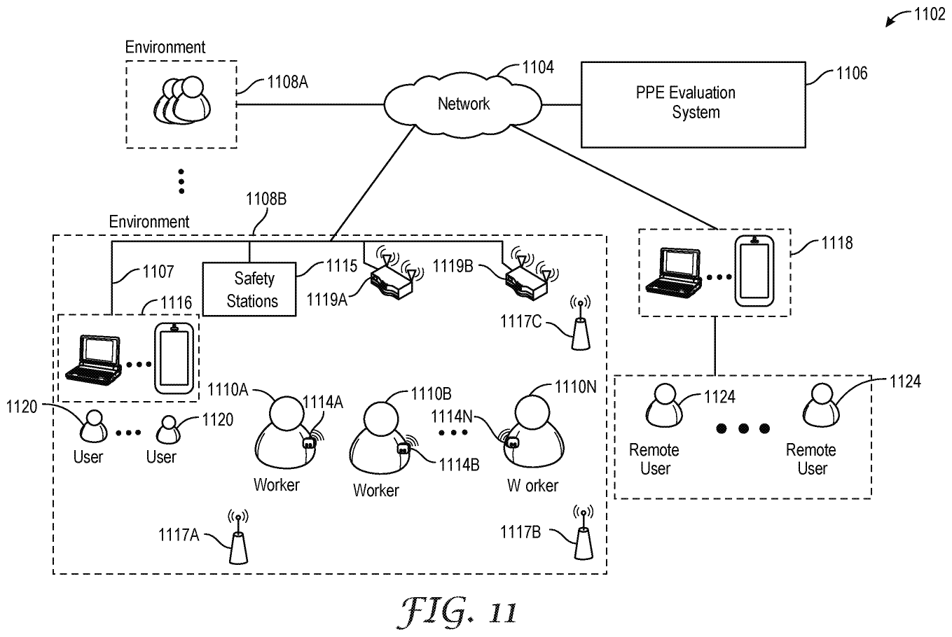

FIG. 10 illustrates a schematic of a PPE evaluation system in accordance with embodiments herein. System 1000 may be built into an environment, for example with a gas-detecting camera 1012, including a CO₂ filter, mounted to a wall, corner or on a mobile unit within the environment. Camera 1012 may also be worn, or built into a PPE or other equipment worn by an individual within an environment. System 1000 may also be part of a distributed system, for example with some portions located physically within an environment, and other portions accessible over a wireless or cloud-based network.

PPE evaluation system 1000 includes an imaging system 1010. Imaging system includes gas detecting camera 1012. Gas detecting camera 1012 may include an IR camera with a CO₂ filter, or may be another suitable gas detector. In some embodiments, camera 1012 is a camera system, with a light source, pan/tilt system, or movement mechanism. For example, camera 1012 may be mounted on a wall, associated with an access point, or mounted on a mobile robot that roams an environment either on a preset or randomized pattern. While a single IR camera 1012 is illustrated in FIG. 10, it is expressly contemplated that multiple IR cameras with CO₂ filters 1012 may be present, or that another camera that captures images outside the IR spectrum is also included. Imaging system 1010 may also include a human detector 1014. In some embodiments, camera 1012 may only capture or record images when a human is detected within a field of view. Such activity may be controlled by imaging controller 1016, which may control movement of a robot system, or a pan/tilt system, or may activate or deactivate a light system, for example. Imaging system 1010 may have other features 1018 as well. It is expressly noted that, while the example of CO₂ detection is discussed herein, that other gases may also be detectable using an IR camera. For example, it may be possible to detect harmful gases infiltrating a PPE as well.

PPE evaluator 1040 may evaluate one or more PPE devices associated with an individual detected by human detector 1014. A PPE detector 1042 may detect one or more PPE devices, for example an RPD as well as eye or face protection. A flow profile generator 1044, based on images collected by imaging system 1010, generates a profile of exhaled air flows. A flow evaluator 1046, based on PPE detector 1042, evaluates the generated flow profile. For example, flow evaluator 1046 may retrieve an expected flow profile, based on the detected PPE and/or an identified PPE wearer, and conduct a comparison, in some embodiments. In another embodiment, the flow profile is analyzed using a machine-learning based algorithm, as described below.

A component evaluator 1048, based on the flow profile from flow profile generator 1044, may evaluate functionality of one or more components of PPE worn by a user. For example, a seal 1048a may be indicated as intact or leaking. A valve 1048b may be indicated as working, leaking or non-functional. Position of straps 1048c may be indicated as in place, too high or too low. A nose foam 1048d may be indicated as properly fitting, too large, too small, improperly sealed, or properly sealed. Other PPE components 1048x may also be evaluated.

PPE evaluator 1040 may have other functionality 1049 as well.

PPE evaluation system also includes a PPE evaluator 1040. PPE evaluator 1040 receives information from PPE detector 1042. PPE detector 1042 isolates and detects PPE in the images received from image detector 1010. PPE detector 1042 detects a PPE in the images, identifies a type, manufacturer, model or size of the PPE, and isolates the PPE in the images.

PPE evaluation system 1000 may provide information, from PPE evaluator 1040, to a function improvement system 1070, which may provide recommendations for improving the fit, function, or both of a PPE for an individual. In some embodiments, function improvement system 1070 is only activated if component evaluator 1048 detects abnormal flow behavior for any of components 1048a-x, or if flow evaluator 1046 indicates abnormal behavior. However, in other embodiments, function improvement system 1070 operates continuously, or periodically, or only when an individual is detected by detector 1014, or based on another trigger. An RPD recommender 1072, for example, may determine whether, based on a generated gas flow profile from generator 1044, that an RPD size, placement or configuration is inappropriate. For example, a user may be instructed to reform a nose clip 1074, reposition straps, or make another change that improves fit and functionality. Function improvement system 1070 may also evaluate a valve 1076 for functionality. A flow profile relative to a valve 1076 should show exhaled air being directed away from an RPD, downward so that any eyewear worn by a user is not fogged.

Other fit improvements 1078 may also be indicated.

In some embodiments, PPE evaluation system 1000 is built into a device with a display component, and a graphical user interface generator 1080 that, based on information from PPE evaluator 1040, and function improvement system 1070, generates a graphical user interface 1080. GUI 1080 may include an image 1082, for example an image taken of an individual by IR camera with CO₂ filter 1012. GUI 1080 may include a quantitative overlay 1086, which indicates where a seal is good or poor. Instructions 1084 may be presented for improving a fit or functionality of the PPE. GUI 1080 may also include other information 1088 or images, such as a sequence of images as captured by IR camera with CO₂ filter 1012.

User input receiver 1004 may receive input from a user. In embodiments where PPE evaluation system 1000 is built into a device, such as a mobile computer, kiosk, mobile phone, tablet, etc., user input receiver 1004 may include a keyboard. In some embodiments, user input receiver 1004 includes a microphone that can pick up audio commands from a user.

Communication component 1008 may communicate with a source remote from PPE evaluation system 1000, for example over a wired, wireless, or cloud-based network. For example, communication component 1008 may communicate with a datastore 1020, sending images 1022 captured from imaging system 1010, sending and receiving flow profiles 1024 from flow profile generator 1044 and flow evaluator 1046. Datastore 1020 may also include a machine learning model and a machine learning model trainer 1026 that improves a machine learning model over time. Datastore may also store other information or algorithms 1028.

Controller 1002 may control activity of components of PPE evaluation system 1000, for example PPE evaluator 1040, function improvement system 1070 or communication component 1008. Controller 1002 may also cause GUI generator 1090 to update a GUI 1080 based on updated images from camera 1012, or based on recommendations from function improvement system 1070. Controller 1002 may also control a movement mechanism 1030, which may move a portion of imaging system 1010, or may move a display component displaying GUI 1080.

PPE evaluation system may include other components 1006 not described in detail with respect to FIG. 10.

System 1000, as discussed herein, may be associated with a stationary or mobile camera within an environment. For example, the camera may be mounted to a wall, or associated with an access point such that a PPE wearer can conduct a functionality or seal test by looking at the camera for a few seconds to inhale and exhale. In other embodiments, system 1000 is integrated into other PPE or wearable equipment. For example, a supervisor may wear camera 1012 integrated into a helmet, strapped to a shoulder or chest such that images may be captured as the supervisor walks around the environment. GUI 1080 may be projected to a heads-up display, on a HOLOLENS™ or other display, such as a mobile phone, computer display or other display within the environment.

FIG. 11 illustrates an environment in which embodiments herein may be useful.

An environment 1102 may represent any number of environments in which workers may need to wear PPE, such as healthcare settings, industrial settings, or any office setting during a pandemic or flu season. Environment 1102 includes a PPE evaluation system 1106 for detecting PPE-wearing individuals and checking the fit of their PPE. PPE evaluation system 1106 may receive images from one or more cameras 1019A as described above, analyze the images to determine exhaled breath flows and, based on the flow paths, generate information about PPE functionality.

PPE evaluation system 1106 may reduce incidents of intentional or unintentional PPE misuse by workers in worksite 1102. PPE evaluation system 1106 may also allow safety professionals to more easily manage health and safety compliance training, and determine which individuals need to change PPE size or models, or who needs retraining on donning PPE correctly.

In general, PPE evaluation system 1106, as described in greater detail herein, is configured to identify PPE-wearing individuals within a worksite, conduct seal checks of those individuals and provide seal check results and recommendations to improve fit, when needed. System 1106 may be connected, through network 1104, to one or more devices or displays 1116 within an environment, or devices or displays 1018, remote from an environment. System 1106 may provide alerts to workers 1110A-1110N when a seal check comes back as failing, as well as provide feedback on how to improve fit.

System 1106 may also be integrated into entry protocols for secured areas within an environment such that workers that do not pass a seal check are restricted out of a secure or dangerous area.

As shown in the example of FIG. 11, system 1102 represents a computing environment in which a computing device within of a plurality of physical environments 1108A, 1108B (collectively, environments 1108) electronically communicate with PPE evaluation system 1106 via one or more computer networks 1104. Each of physical environments 1108A and 1108B represents a physical environment, such as a work environment, in which one or more individuals, such as workers 1110, utilize respiratory protective devices while engaging in tasks or activities within the respective environment.

In this example, environment 1108A is shown as generally as having workers 1110, while environment 1108B is shown in expanded form to provide a more detailed example. In the example of FIG. 11, a plurality of workers 1110A-1110N may be wearing a variety of different PPE.

In some examples, each of environments 1108 include computing facilities, such as displays 1116, by which workers 1110 can communicate with PPE evaluation system 1106. For examples, environments 1108 may be configured with wireless technology, such as 802.11 wireless networks, 802.15 ZigBee networks, and the like. In the example of FIG. 11, environment 1108B includes a local network 1107 that provides a packet-based transport medium for communicating with PPE evaluation system 1106 via network 1104. In addition, environment 1108B may include a plurality of wireless access points 1119A, 1119B that may be geographically distributed throughout the environment to provide support for wireless communications throughout the work environment.

As shown in the example of FIG. 11, an environment, such as environment 1108B, may also include one or more wireless-enabled beacons, such as beacons 1117A-1117C, that provide accurate location information within the work environment. For example, beacons 1117A-1117C may be GPS-enabled such that a controller within the respective beacon may be able to precisely determine the position of the respective beacon. Alternatively, beacons 1117A-1117C may include a pre-programmed identifier that is associated in PPE evaluation system 1106 with a particular location. Based on wireless communications with one or more of beacons 1117, or data hub 1114 worn by a worker 1110, PPE evaluation system 1106 is configured to determine the location of the worker within work environment 1108B. In this way, event data reported to PPE evaluation system 1106 may be stamped with positional information.

In example implementations, an environment, such as environment 1108B, may also include one or more safety stations 1115 distributed throughout the environment. Safety stations 1115 may allow one of workers 1110 to conduct a PPE evaluation by positioning themselves in front of a camera and following instructions provided either audibly, visually or otherwise by safety station 1115.

In addition, each of environments 1108 include computing facilities that provide an operating environment for end-user computing devices 1116 for interacting with PPE evaluation system 1106 via network 1104. For example, each of environments 1108 typically includes one or more safety managers or supervisors, represented by users 1120 or remote users 1124, are responsible for overseeing safety compliance within the environment. In general, each user 1120 or 1124 interacts with computing devices 1116, 1118 to access PPE evaluation system 1106. For example, the end-user computing devices 1116, 1118 may be laptops, desktop computers, mobile devices such as tablets or so-called smart cellular phones.

PPE evaluation system 1106 may be configured to actively monitor workers 1110A-1110N and other users 1120 within an environment 1108 both for correct usage of RPDs. Referring to FIG. 11, a worksite may have one or more cameras 1119A, either fixed within the worksite, mobile (e.g. drone, robot or equipment-mounted) or associated with a worker 1110A-1110N (e.g. an augmented reality headset or other camera worn in association with PPE, etc.). Using the one or more cameras, PPE evaluation system 1106 may be able to automatically identify whether or not a worker 1110A-1110N has PPE functioning properly without the worker 1110A-1110N being interrupted during a task.

As another example, PPE evaluation system 1106 may further trigger an alert if a PPE evaluation system 1106 detects a nonfunctional component of a PPE device or that function of one or more PPE could be improved with reconfiguration. The alert may be sent to worker 1110, either through a communication feature of a PPE, a separate communication device, or through a public address system within the environment. A PPE evaluation result or may also be sent to a supervisor or safety officer associated with the environment 1108 as well. PPE evaluation results items may also be tracked and stored within a database, as described herein.

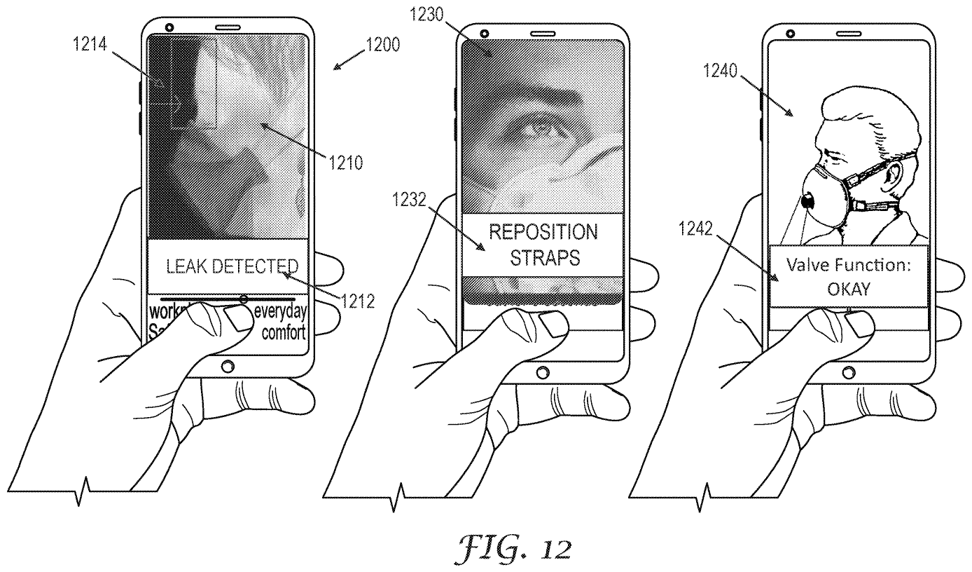

FIGS. 12A-12C illustrate some user interfaces of a mobile application for checking functionality of a PPE in accordance with embodiments herein. FIG. 12A illustrates a user interface 1200 that may be presented to either a wearer of a PPE or a supervisor when a functional defect is detected. An individual 1210 is illustrated in an image taken from a gas detecting camera. A leak indication 1214 is on the screen, as well as a notification 1212 of a functional defect of the PPE. It may be possible for a user to move from user interface 1200 to user interface 1230, of FIG. 12B, where there is an indication of how to fix the functional defect detected. Notification 1232 indicates that repositioning straps may correct the detected leak.

FIG. 12C illustrates user interface 1240, which shows a schematic of a user and a detected flow path of exhaled air. As indicated by notification 1242, based on the flow profile generated by a system herein, the valve is indicated as functioning properly.

An application such as that illustrated in FIGS. 12A-12C may be intended for general public use, for example for individuals wanting to wear PPE to limit spread of an illness or to prevent themselves from getting sick. However, the graphical user interfaces represented in FIGS. 12A-12C. may also be presented on a display associated with a kiosk or otherwise associated with a work environment, such as environment 1102.

The PPE evaluation results and recommendations may be generated locally, using a CPU of the mobile computing device, in one embodiment. In another embodiment, the images captured of the user are wirelessly transferred to a remote server that generates a temperature profile and detects leaks by comparing the generated temperature profile to a database of profiles indicative of different leak locations.

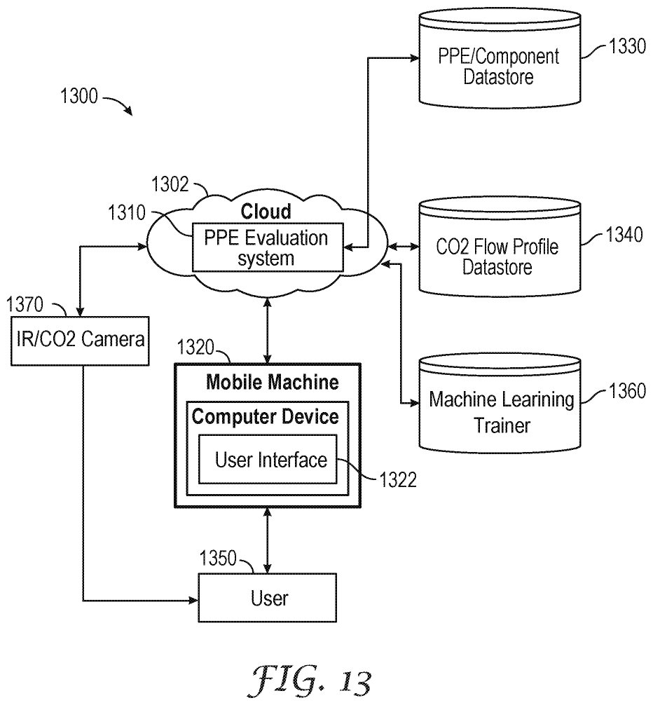

FIG. 13 is a block diagram of a PPE evaluation system architecture. The remote server architecture 1300 illustrates one embodiment of an implementation of PPE evaluation system 1310. As an example, remote server architecture 1300 can provide computation, software, data access, and storage services that do not require end-user knowledge of the physical location or configuration of the system that delivers the services. In various embodiments, remote servers can deliver the services over a wide area network, such as the internet, using appropriate protocols. For instance, remote servers can deliver applications over a wide area network and they can be accessed through a web browser or any other computing component. Software or components shown or described in FIGS. 1-12 as well as the corresponding data, can be stored on servers at a remote location. The computing resources in a remote server environment can be consolidated at a remote data center location or they can be dispersed. Remote server infrastructures can deliver services through shared data centers, even though they appear as a single point of access for the user. Thus, the components and functions described herein can be provided from a remote server at a remote location using a remote server architecture. Alternatively, they can be provided by a conventional server, installed on client devices directly, or in other ways.

In the example shown in FIG. 13, some items are similar to those shown in earlier figures. FIG. 13 specifically shows that a PPE evaluation system 1310 can be located at a remote server location 1302. Therefore, computing device 1320 accesses those systems through remote server location 1302. User 1350 can use computing device 1320 to access user interfaces 1322 as well. For example, a user 1350 may be a user wanting to check a fit of their respiratory protection device while sitting in a parking lot, and interacting with an application on the user interface 1322 of their smartphone 1320, or laptop 1320, or other computing device 1320.

FIG. 13 shows that it is also contemplated that some elements of systems described herein are disposed at remote server location 1302 while others are not. By way of example, storage 1330 or 1340, machine learning trainer 1360, or a camera 1370 can be disposed at a location separate from location 1302 and accessed through the remote server at location 1302. Regardless of where they are located, they can be accessed directly by computing device 1320, through a network (either a wide area network or a local area network), hosted at a remote site by a service, provided as a service, or accessed by a connection service that resides in a remote location. Also, the data can be stored in substantially any location and intermittently accessed by, or forwarded to, interested parties. For instance, physical carriers can be used instead of, or in addition to, electromagnetic wave carriers. This may allow a user 1350 to interact with system 1310 through their computing device 1320, to initiate a seal check process.

It will also be noted that the elements of systems described herein, or portions of them, can be disposed on a wide variety of different devices. Some of those devices include servers, desktop computers, laptop computers, imbedded computer, industrial controllers, tablet computers, or other mobile devices, such as palm top computers, cell phones, smart phones, multimedia players, personal digital assistants, etc.

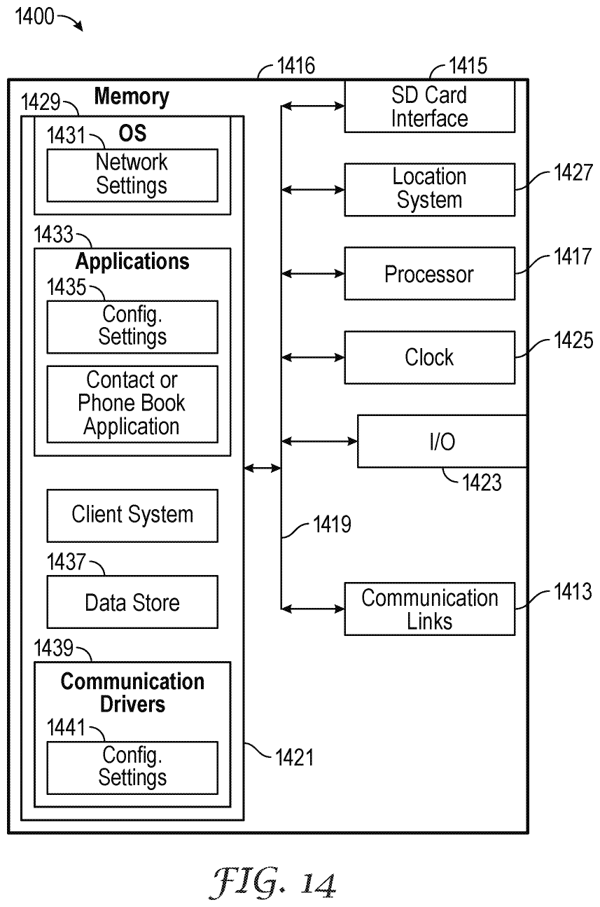

FIGS. 14-16 illustrate example devices that can be used in the embodiments shown in previous Figures. FIG. 14 illustrates an example mobile device that can be used in the embodiments shown in previous Figures. FIG. 14 is a simplified block diagram of one illustrative example of a handheld or mobile computing device that can be used as either a user's device or a supervisor/safety officer device, for example, in which the present system (or parts of it) can be deployed. For instance, a mobile device can be deployed in the operator compartment of computing device for use in generating, processing, or displaying the data.

FIG. 14 provides a general block diagram of the components of a mobile cellular device 1416 that can run some components shown and described herein. Mobile cellular device 1416 interacts with them or runs some and interacts with some. In the device 1416, a communications link 1413 is provided that allows the handheld device to communicate with other computing devices and under some embodiments provides a channel for receiving information automatically, such as by scanning. Examples of communications link 1413 include allowing communication though one or more communication protocols, such as wireless services used to provide cellular access to a network, as well as protocols that provide local wireless connections to networks.

In other examples, applications can be received on a removable Secure Digital (SD) card that is connected to an interface 1415. Interface 1415 and communication links 1413 communicate with a processor 1417 (which can also embody a processor) along a bus 1419 that is also connected to memory 1421 and input/output (I/O) components 1423, as well as clock 1425 and location system 1427.

I/O components 1423, in one embodiment, are provided to facilitate input and output operations and the device 1416 can include input components such as buttons, touch sensors, optical sensors, microphones, touch screens, proximity sensors, accelerometers, orientation sensors and output components such as a display device, a speaker, and or a printer port. Other I/O components 1423 can be used as well.

Clock 1425 illustratively comprises a real time clock component that outputs a time and date. It can also provide timing functions for processor 1417.

Illustratively, location system 1427 includes a component that outputs a current geographical location of device 1416. This can include, for instance, a global positioning system (GPS) receiver, a LORAN system, a dead reckoning system, a cellular triangulation system, or other positioning system. It can also include, for example, mapping software or navigation software that generates desired maps, navigation routes and other geographic functions.

Memory 1421 stores operating system 1429, network settings 1431, applications 1433, application configuration settings 1435, data store 1437, communication drivers 1439, and communication configuration settings 1141. Memory 1421 can include all types of tangible volatile and non-volatile computer-readable memory devices. It can also include computer storage media (described below). Memory 1421 stores computer readable instructions that, when executed by processor 1417, cause the processor to perform computer-implemented steps or functions according to the instructions. Processor 1417 can be activated by other components to facilitate their functionality as well. It is expressly contemplated that, while a physical memory store 1421 is illustrated as part of a device, that cloud computing options, where some data and/or processing is done using a remote service, are available.

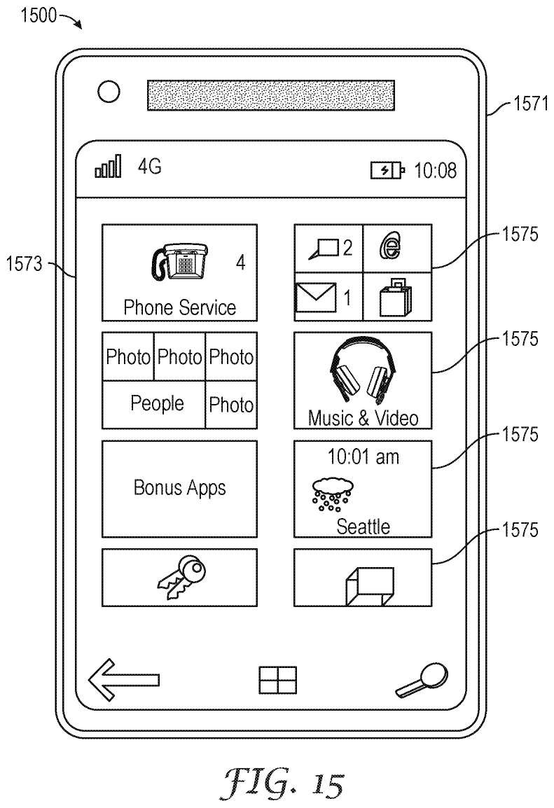

FIG. 15 shows that the device can also be a smart phone 1571. Smart phone 1571 has a touch sensitive display 1573 that displays icons or tiles or other user input mechanisms 1575. Mechanisms 1575 can be used by a user to run applications, make calls, perform data transfer operations, etc. In general, smart phone 1571 is built on a mobile operating system and offers more advanced computing capability and connectivity than a feature phone. Note that other forms of the devices are possible.

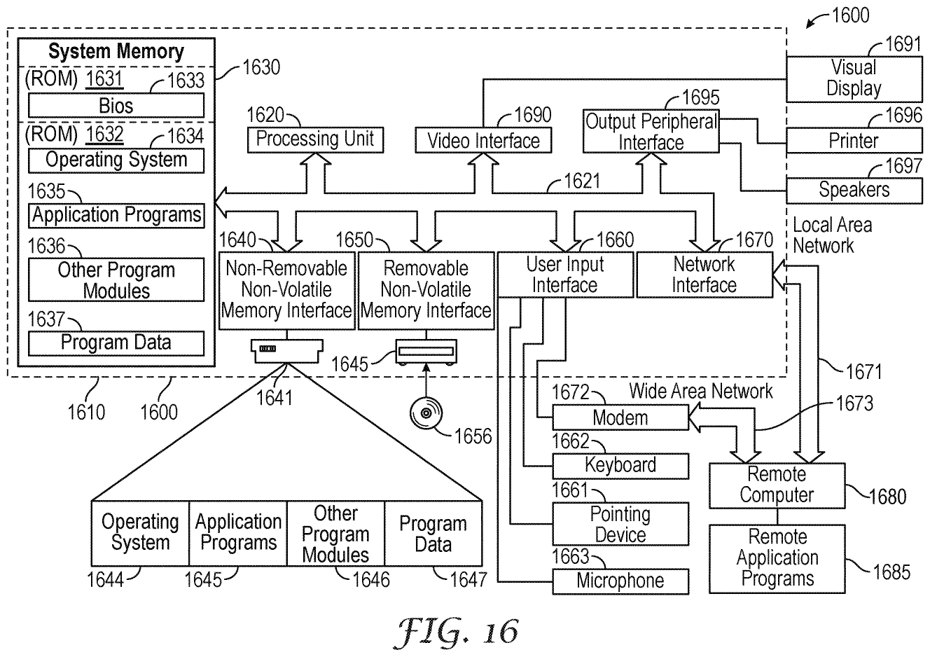

FIG. 16 is one example of a computing environment in which elements of systems and methods described herein, or parts of them (for example), can be deployed. With reference to FIG. 16, an example system for implementing some embodiments includes a general-purpose computing device in the form of a computer 1610. Components of computer 1610 may include, but are not limited to, a processing unit 1620 (which can comprise a processor), a system memory 1630, and a system bus 1621 that couples various system components including the system memory to the processing unit 1620. The system bus 1621 may be any of several types of bus structures including a memory bus or memory controller, a peripheral bus, and a local bus using any of a variety of bus architectures. Memory and programs described with respect to systems and methods described herein can be deployed in corresponding portions of FIG. 16.

Computer 1610 typically includes a variety of computer readable media. Computer readable media can be any available media that can be accessed by computer 1610 and includes both volatile/nonvolatile media and removable/non-removable media. By way of example, and not limitation, computer readable media may comprise computer storage media and communication media. Computer storage media is different from, and does not include, a modulated data signal or carrier wave. It includes hardware storage media including both volatile/nonvolatile and removable/non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 1610. Communication media may embody computer readable instructions, data structures, program modules or other data in a transport mechanism and includes any information delivery media. The term “modulated data signal” means a signal that has one or more of its characteristics set or changed in such a manner as to encode information in the signal.

The system memory 1630 includes computer storage media in the form of volatile and/or nonvolatile memory such as read only memory (ROM) 1631 and random-access memory (RAM) 1632. A basic input/output system 1633 (BIOS) containing the basic routines that help to transfer information between elements within computer 1610, such as during start-up, is typically stored in ROM 1331. RAM 1632 typically contains data and/or program modules that are immediately accessible to and/or presently being operated on by processing unit 1620. By way of example, and not limitation, FIG. 16 illustrates operating system 1634, application programs 1635, other program modules 1636, and program data 1637.

The computer 1610 may also include other removable/non-removable and volatile/nonvolatile computer storage media. By way of example only, FIG. 16 illustrates a hard disk drive 1641 that reads from or writes to non-removable, nonvolatile magnetic media, nonvolatile magnetic disk 1652, an optical disk drive 1655, and nonvolatile optical disk 1656. The hard disk drive 1641 is typically connected to the system bus 1621 through a non-removable memory interface such as interface 1640, and optical disk drive 1655 are typically connected to the system bus 1621 by a removable memory interface, such as interface 1650.

Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (e.g., ASICs), Application-specific Standard Products (e.g., ASSPs), System-on-a-chip systems (SOCs), Complex Programmable Logic Devices (CPLDs), etc.

The drives and their associated computer storage media discussed above and illustrated in FIG. 16, provide storage of computer readable instructions, data structures, program modules and other data for the computer 1610. In FIG. 16, for example, hard disk drive 1641 is illustrated as storing operating system 1644, application programs 1645, other program modules 1646, and program data 1647. Note that these components can either be the same as or different from operating system 1634, application programs 1635, other program modules 1636, and program data 1637.

A user may enter commands and information into the computer 1610 through input devices such as a keyboard 1662, a microphone 1663, and a pointing device 1661, such as a mouse, trackball or touch pad. Other input devices (not shown) may include a joystick, game pad, satellite receiver, scanner, a gesture recognition device, or the like. These and other input devices are often connected to the processing unit 1620 through a user input interface 1660 that is coupled to the system bus but may be connected by other interface and bus structures. A visual display 1691 or other type of display device is also connected to the system bus 1621 via an interface, such as a video interface 1690. In addition to the monitor, computers may also include other peripheral output devices such as speakers 1697 and printer 1696, which may be connected through an output peripheral interface 1695.

The computer 1610 is operated in a networked environment using logical connections, such as a Local Area Network (LAN) or Wide Area Network (WAN) to one or more remote computers, such as a remote computer 1680. The computer may also connect to the network through another wired connection. A wireless network, such as WiFi™ may also be used.

When used in a LAN networking environment, the computer 1610 is connected to the LAN 1671 through a network interface or adapter 1670. When used in a WAN networking environment, the computer 1610 typically includes a modem 1672 or other means for establishing communications over the WAN 1673, such as the Internet. In a networked environment, program modules may be stored in a remote memory storage device. FIG. 16 illustrates, for example, that remote application programs 1685 can reside on remote computer 1680.

In the present detailed description of the preferred embodiments, reference is made to the accompanying drawings, which illustrate specific embodiments in which the invention may be practiced. The illustrated embodiments are not intended to be exhaustive of all embodiments according to the invention. It is to be understood that other embodiments may be utilized and structural or logical changes may be made without departing from the scope of the present invention. The following detailed description, therefore, is not to be taken in a limiting sense, and the scope of the present invention is defined by the appended claims.

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein.

As used in this specification and the appended claims, the singular forms “a,” “an,” and “the” encompass embodiments having plural referents, unless the content clearly dictates otherwise. As used in this specification and the appended claims, the term “or” is generally employed in its sense including “and/or” unless the content clearly dictates otherwise.

If implemented in software, the techniques may be realized at least in part by a computer-readable medium comprising instructions that, when executed in a processor, performs one or more of the methods described above. The computer-readable medium may comprise a tangible computer-readable storage medium and may form part of a computer program product, which may include packaging materials. The computer-readable storage medium may comprise random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The computer-readable storage medium may also comprise a non-volatile storage device, such as a hard-disk, magnetic tape, a compact disk (CD), digital versatile disk (DVD), Blu-ray disk, holographic data storage media, or other non-volatile storage device.

The term “processor,” as used herein may refer to any of the foregoing structure or any other structure suitable for implementation of the techniques described herein. In addition, in some aspects, the functionality described herein may be provided within dedicated software modules or hardware modules configured for performing the techniques of this disclosure. Even if implemented in software, the techniques may use hardware such as a processor to execute the software, and a memory to store the software. In any such cases, the computers described herein may define a specific machine that is capable of executing the specific functions described herein. Also, the techniques could be fully implemented in one or more circuits or logic elements, which could also be considered a processor.

Here, the exemplary embodiments of the present invention have been described in detail, but it should be understood that the present invention is not limited to the specific embodiments described and illustrated in detail above. Those skilled in the art can make various variations and variants of the present invention without departing from the gist and scope of the present invention. All these variations and variants fall within the scope of the present invention. Moreover, all components described here can be replaced by other technically equivalent components.

A system for a PPE device is presented that includes an image capturing device that captures an image sequence of a user wearing the PPE device. The system also includes a gas profile generator that analyzes the image sequence and generates a gas profile of the PPE device. The system also includes a PPE identifier that identifies a component of the PPE device. The system also includes an analyzer that based on the generated gas profile, generates a function status of the component of the PPE device. The system also includes a communication component that communicates the status.

The system may be implemented such that the component is a valve, and the function status is a working valve, a partial blockage of the valve, a full blockage of the valve, or a nonfunctional valve.

The system may be implemented such that the component is a strap, and the function status is a misplacement.

The system may be implemented such that it includes a function improvement system that generates an adjustment based on the status.

The system may be implemented such that the function improvement system analyzes the image sequence and compares the image sequence to a dataset of image sequences and, based on the comparison, generates the adjustment.

The system may be implemented such that the PPE device is a first PPE device. The PPE identifier identifies a second PPE device. Based on the generated gas profile, the adjustment is generated for the second PPE device.

The system may be implemented such that the first PPE device is a respiratory protection device, and the second PPE device is an eyewear device.

The system may be implemented such that the component is a face covering portion of a respiratory protection device, and the function status is a breathability status.

The system may be implemented such that the component is a fit improvement device, and the function status is a fit indication.

The system may be implemented such that the gas includes carbon dioxide, and the image capturing device includes a carbon dioxide filter.

The system may be implemented such that the gas includes water vapor.

The system may be implemented such that the analyzer is a leak detector, and the function status is a leak location indication.

The system may be implemented such that the gas profile generator generates the gas profile based on a set of images of an exhale of a wearer of the PPE.

The system may be implemented such that the image sequence is from a video capturing the exhale.

The system may be implemented such that it includes an image identifier that identifies the set of images as indicative of the exhale.

The system may be implemented such that the communication component communicates the function status to a display.

The system may be implemented such that the communication component communicates the image sequence to the display.

The system may be implemented such that the IR camera automatically captures the image sequence upon detecting the user in a field of view of the camera.

The system may be implemented such that the camera is part of a stationary system.

The system may be implemented such that the camera is part of a mobile system.

The system may be implemented such that the system is a mobile computing system.

The system may be implemented such that the IR camera is built into the mobile computing system.

The system may be implemented such that the IR camera includes a photon detector sensitive in the mid-range IR where CO2 has a strong absorption band.

The system may be implemented such that the communication component includes a graphical user interface generator that generates a graphical user interface for a display of the mobile computing system.

The system may be implemented such that the mobile computing system is a mobile phone.

The system may be implemented such that the mobile computing system is a tablet.

The system may be implemented such that the image capture is triggered by a touch-free command.

The system may be implemented such that the touch-free command is an audio command from the user.

The system may be implemented such that the communication component communicates the status to a graphical user interface generator. The graphical user interface generator generates a graphical user interface that displays a function improvement.

The system may be implemented such that the PPE is a respiratory protection device.

The system may be implemented such that the PPE is a supplied air respirator or a self-contained breathing apparatus (SCBA).

The system may be implemented such that the PPE is a helmet.

The system may be implemented such that the PPE is a face shield.

A method for providing a functional status of a respiratory protection device is presented that includes capturing an infrared image of a wearer of the respiratory protection device. The method also includes generating a gas flow profile of a gas, based on the image, for the respiratory protection device, from the captured image. The method also includes, based on the gas flow profile, identifying a functional status of a component of the respiratory protection device. The method also includes generating a function improvement for the respiratory protection device, based on the generated gas profile. The method also includes communicating the function improvement, using a communication component.

The method may be implemented such that the component is an exhalation valve. The functional status is a functional valve, a non-functional valve, a partial blockage of the valve, or a full blockage of the valve.

The method may be implemented such that the component is a strap, and the functional status is a misplacement.

The method may be implemented such that generating the function improvement includes analyzing the image and comparing the image to a dataset of images and, based on the comparison, generating the function improvement.

The method may be implemented such that the PPE device is a first PPE device and the functional adjustment is generated for the second PPE device.

The method may be implemented such that the first device is a respiratory protection device, and the second PPE device is a safety eyewear.

The method may be implemented such that the component is the filter portion of a respiratory protection device, and the function status is a breathability status.

The method may be implemented such that the component is a fit improvement device, and the function status is a fit indication.

The method may be implemented such that the gas includes carbon dioxide and the IR camera has a carbon dioxide filter.

The method may be implemented such that the gas includes water vapor.

The method may be implemented such that the image capturing device captures the wearer exhaling.

The method may be implemented such that the image capturing device captures the wearer inhaling.

The method may be implemented such that the image is a frame from a video captured by the image capturing device.

The method may be implemented such that the functional improvement is communicated to a display.

The method may be implemented such that the functional improvement is communicated to an access point. Access is denied until the functional improvement is implemented.

The method may be implemented such that capturing the image is done automatically when the wearer is detected in a field of view of the camera.

The method may be implemented such that capturing the image is done automatically when a wearer exhalation is detected.

The method may be implemented such that capturing the image is done automatically when a wearer inhalation is detected.

The method may be implemented such that it includes the wearer activating an application on a computing device and, based on the activation, automatically completing the steps of capturing, generating and identifying.

The method may be implemented such that the computing device includes the camera.

The method may be implemented such that the camera is separate from the computing device.

The method may be implemented such that identifying the functional status includes: identifying a type of the component of the respiratory protection, comparing the gas flow profile to a database of gas flow profiles associated with the component, and determining, based on the comparison, that the component has the functional status.

A respiratory protection device evaluation system is presented that includes an IR camera with a field of view configured to, when an individual is detected within the field of view, capture a sequence of IR images of the individual. The system also includes a gas flow profile generator that, based on the images, generates a gas flow profile of a gas flow from a respiratory protection device worn by the individual. The system also includes a respiratory protection device evaluator that, based on the gas flow profile, generates a functional status for a component of the respiratory protection device. The system also includes a communication module that communicates the functional status, using a communication component.

The system may be implemented such that the component is an exhalation valve, and the functional status is a valve function status.

The system may be implemented such that the component is the filter portion, and the functional status is a breathability.

The system may be implemented such that the component is a custom fit aid, and the functional status is a fit quality.

The system may be implemented such that the component is a strap, and the functional status is a strap placement.

The system may be implemented such that the gas includes carbon dioxide and the IR camera includes a carbon dioxide filter.

The system may be implemented such that the gas includes water vapor.

The system may be implemented such that the sequence of IR images are a video captured by the IR camera.

The system may be implemented such that the respiratory protection device evaluator compares the generated gas flow profile to a database of gas flow profiles.

The system may be implemented such that the system is mounted to a mobile station configured to move about an environment.

The system may be implemented such that the mobile station automatically moves about the environment according to a movement pattern.

The system may be implemented such that the mobile station is associated with a second individual.

The system may be implemented such that the system is incorporated into a device including the IR camera.

The system may be implemented such that the IR camera is a stationary camera within an environment.

The system may be implemented such that the communication module provides the functional status to a log for the individual.

1. A system for a PPE device, the system comprising:
an image capturing device that captures an image sequence of a user wearing the PPE device;
a gas profile generator that analyzes the image sequence and generates a gas profile of the PPE device;
a PPE identifier that identifies a component of the PPE device;
an analyzer that based on the generated gas profile, generates a function status of the component of the PPE device; and
a communication component that communicates the status.

2. The system of claim 1, wherein the component is a valve, and wherein the function status is a working valve, a partial blockage of the valve, a full blockage of the valve, or a nonfunctional valve.

3. The system of claim 1, wherein the component is a strap, and wherein the function status is a misplacement.

4-9. (canceled)

10. The system of claim 1, wherein a gas that is a subject of the gas profile comprises carbon dioxide, and wherein the image capturing device comprises a carbon dioxide filter.

11. The system of claim 10, wherein the gas comprises water vapor.

12. The system of claim 1, wherein the analyzer is a leak detector, and wherein the function status is a leak location indication.

13. The system of claim 1, wherein the gas profile generator generates the gas profile based on a set of images of an exhale of a wearer of the PPE.

14. The system of claim 13, wherein the image sequence is from a video capturing the exhale.

15. The system of claim 13, and further comprising an image identifier that identifies the set of images as indicative of the exhale.

16. The system of claim 1, wherein the communication component communicates the function status to a display.

17. The system of claim 16, wherein the communication component communicates the image sequence to the display.

18. (canceled)

19. The system of claim 1, wherein the image capturing device is built into the mobile computing system.

20. The system of claim 1, wherein the image capturing device comprises a photon detector sensitive in the mid-range IR where CO2 has a strong absorption band.

21. The system of claim 1, wherein the communication component comprises a graphical user interface generator that generates a graphical user interface for a display of the mobile computing system.

22-24. (canceled)

25. A method for providing a functional status of a respiratory protection device, the method comprising:
capturing an infrared image, using an the image capturing device, of a wearer of the respiratory protection device;
generating a gas flow profile of a gas, based on the IR image, for the respiratory protection device, from the captured image;
based on the gas flow profile, identifying a functional status of a component of the respiratory protection device;
generating a function improvement for the respiratory protection device, based on the generated gas profile; and
communicating the function improvement, using a communication component.

26-38. (canceled)
